(19) United States
(12) Patent Application Publication
(10) Pub. No.: US 2006/0222050 A1
(43) Pub. Date: Oct. 5, 2006

(54) Ceramic receptacle for temperature probes and the like

(75) Inventors: Michael Byrne, Laredo, TX (US); Gustavo Canales, Nuevo Laredo (MX); Jose Rodolfo Pena Casillas, Nuevo Laredo (MX); Angel Cuellar Espinoza, Nuevo Laredo (MX); James D. Kimble, DeKalb, IL (US); Brian L. Orloff, Plainfield, IL (US); Pablo Vallejo, Nuevo Laredo (MX)

Correspondence Address: REINHART BOERNER VAN DEUREN P.C., 483 NORTH MULFORD ROAD, SUITE 7, ROCKFORD, IL, 61107, US

(73) Assignee: Robertshaw Controls Company, Richmond, VA (US)

(21) Appl. No.: 11/095,865

(22) Filed: Mar. 31, 2005

(51) Int. Cl. G01K 13/00; G01K 7/00; G01K 1/00

(52) U.S. Cl. 374/208; 374/149; 374/179

(57) ABSTRACT

An insulative, high temperature receptacle is provided. Preferably the receptacle is made from ceramic using a ceramic injection molding (CIM) or dry press operation. Such an operation allows for a single piece ceramic receptacle body to include features for assembly to be integrated into the single piece. Conductive electrical terminals may then be inserted to complete the assembly. The receptacle body includes a mounting interface that allows the receptacle to be mounted in, for example, an appliance. Since ceramic is non-conductive, a standard inexpensive two-wire temperature probe may be utilized for applications in a cooking appliance. The ceramic body includes a groove to receive a male connector portion, and the electrical terminals are biased to provide a secure electrical and mechanical contact during operation. A terminal separation structure is also provided to ensure electrical isolation between the electrical terminals thereof.

### FIELD OF THE INVENTION

The present invention relates generally to electrical receptacles, and more particularly to a high temperature, isolative electrical receptacle for temperature probes.

### BACKGROUND OF THE INVENTION

An important aspect of any cooking application, be it commercial or residential, is ensuring that the food being prepared is adequately cooked throughout. While it may be appropriate for many recipes and food types to simply cook at a pre-selected temperature for a particular period of time, such is not the case when preparing many meat types such as turkey, roasts, whole chickens, etc. This is because the size of these food types often vary, and while general guidelines with regard to a number of minutes per pound to achieve a particular cooked result, these guidelines can only serve as that, just a guide. To ensure that the food is actually cooked throughout to the desired and safe degree of doneness, it is important to use a temperature probe.

To use a temperature probe during a cooking application, the temperature sensing end of the probe is inserted into the item being cooked to a point sufficient to monitor the internal temperature of the item during the cooking process. To accommodate the use of such temperature probes, also known as meat probes, appliance manufacturers have integrated the temperature sensing circuitry used in conjunction with the meat probe into the design of the appliance itself. This precludes the necessity of running a temperature probe wire out of the oven cavity to connect to an external temperature measuring device as is often used with older style ranges, grills, etc. The appliance then either displays the meat temperature on the appliance itself, or utilizes the temperature input to control a programmed cooking cycle, to signal when the meat has reached the preset or desired level of doneness, etc.

Integrating the temperature probe interface into the interior cavity of the range has presented some unique problems. While external temperature sensing circuitry may utilize a plastic housing into which the temperature probe is plugged, usage of plastic components or parts within an oven's cavity presents unique problems. For example, many modern ranges provide a clean cycle during which the internal cavity temperature of the oven reaches temperatures in excess of 900° F. As such, current appliances having a temperature probe interface utilize some type of plated, screw-machine steel with integrated terminals for attaching the electrical wires leading to the temperature sensing or control circuitry. The contacts within the cylindrical steel receptacle are typically made from brass or nickel plated steel. Unfortunately, the placement and securing of these contacts within the cylindrical screw-machined steel receptacle adds unacceptably to the manufacturing cost of this component.

With the usage of the steel receptacle, another problem foreign to the usage of a separate temperature probe also became apparent. The temperature probes previously used with the external temperature display circuitry utilized a simple, inexpensive two-wire temperature probe configuration. However, once the temperature sensing or control circuitry was integrated into the appliance itself, it became apparent that the inexpensive two-wire temperature probe could no longer be used. This is because, with modern micro-processor-based electronics included in such modern appliances, peripheral attachments are required to be electrically isolated from chassis ground of the appliance. Since the steel receptacle is mounted within the cavity of the oven, and because steel is electrically conductive, the receptacle itself is inherently coupled to the chassis ground. As a result, a much more expensive three-wire temperature probe is required to be used. To achieve the electrical isolation from chassis ground, the third wire, or ground wire, of the temperature probe is not electrically connected.

While the current design operates sufficiently, the high cost of manufacture of the receptacle and of the required three terminal temperature probe precludes the application of such a device in many models of ranges. This, despite the fact that ensuring that food items are properly cooked throughout is an important aspect to consumer health.

There exists, therefore, a need in the art for a temperature probe receptacle that is inexpensive to manufacture, that can be applied to the operating environment of a consumer or commercial cooking appliance, and that allows for the use of an inexpensive two-wire temperature probe.

### BRIEF SUMMARY OF THE INVENTION

In view of the above, it is an objective of the present invention to provide a new and improved receptacle for temperature probes and the like. More specifically, it is an objective of the present invention to provide a new and improved receptacle that may be mounted in high temperature application environments, that provides electrical isolation, and that is inexpensive to manufacture.

In one embodiment of the present invention the new and improved receptacle is made of ceramic. Preferably, the receptacle is made by a ceramic injection molded (CIM) or ceramic dry press process, and includes features for assembly to be integrated into a single piece, thereby resulting in a lower manufacturing cost. By utilizing ceramic, the receptacle is able to withstand exposure to oven temperatures in excess of 900° F. during self-cleaning modes of operation, and provides electrical isolation from chassis ground, which enables the usage of common, inexpensive, two-wire temperature probes.

In one embodiment of the present invention, the dry press or injection molded ceramic receptacle includes slots to accommodate the electrical terminals that will make electrical contact with the male connector of the temperature probe. In other embodiments, the dry press or injection molded ceramic receptacle includes mounting holes to affix the electrical terminal in place. During the molding process, the ceramic receptacle housing is typically fired at a temperature in the 2200° F. to 2500° F. range as is well known in the art. Once the ceramic housing has been fired, the electrical contacts may then be inserted into the slots or otherwise affixed to the housing via mounting holes provided therein to complete the assembly of the ceramic receptacle. This allows typical materials to be used for the electrical terminals since they will not be exposed to the firing temperatures of the ceramic forming process.

To mount the receptacle in the oven cavity, one embodiment of the present invention provides molded or pressed threading that may be used in conjunction with a bolt or threaded receiver to hold the receptacle in place within the sidewall of the cavity. In an alternate embodiment, the ceramic receptacle is provided with a cam locking structure to position and hold the receptacle in place. Alternatively, a clip retainer or other mechanism well known in the art may be utilized to position the receptacle in the sidewall of the oven cavity.

A receptacle assembly constructed in accordance with a preferred embodiment comprises an insulative housing that defines therein a connector receiver bore. A groove is also formed that is in communication with the bore. In one embodiment, a pair of terminal receiving slots extending through the housing and positioned along a longitudinal axis of the groove are also included. In other embodiments, the electrical terminal are held in position by rivets or other fasteners accommodated in mounting holes provided in the housing for this purpose. The assembly also includes a pair of electrical terminals positioned in the pair of terminal receiving slots or held in place by the fasteners. These electrical terminals have a contact surface positioned in a radial spaced relation to the longitudinal axis of the groove. In one embodiment, the terminals are positioned at approximately the same radial position, while in another embodiment the terminals are positioned at opposite radial positions.

For appliance applications, the housing further defines a cavity interface portion around the connector receiver bore. In one embodiment, the cavity interface portion includes a threaded exterior surface. Alternatively, the cavity interface portion includes a cam lock formed on the exterior surface. Still further, an alternate embodiment includes a C-clip or other retaining mechanism to hold the receptacle in place. To aid in positioning the receptacle, the housing further defines a shoulder portion laterally spaced from an exterior end of the bore. In one embodiment, the housing further defines a terminal separation structure extending between the pair of terminal receiving slots.

In one embodiment each of the pair of electrical terminals includes a terminal shoulder. Each of the terminal receiving slots in this embodiment also includes a slot shoulder, and the terminal shoulder and the slot shoulder are positioned relative to one another to prevent the electrical terminal from being inserted too far in the terminal receiving slot. Preferably, each of the pair of terminal receiving slots is positioned in a spaced relationship to one another along the longitudinal axis. In one embodiment, each of the pair of electrical terminals includes a locking tab formed thereon. Each of the terminal receiving slots include at least one locking tab receiver formed therein The locking tab and the locking tab receiver are operative to inhibit removal of the electrical terminal from the terminal receiving slot once inserted therein.

In another embodiment, each of the electrical terminals includes a first and a second angled surface on either side of a central contact surface at one end thereof, and a terminal connector at an opposite end thereof. Preferably, each of the electrical terminals further includes a biased transition surface between the one end and the opposite end thereof. This biased transition surface positions the one end out of the plane of the opposite end. Preferably, the biased transition surface positions the one end at an acute angle relative to the opposite end. In an alternate embodiment, the terminals have a convex curved surface relative to the axis of insertion of the male connector. Such a convex curved surface provides a biasing force on the male connector and facilitates insertion and removal of the connector.

In a highly preferred embodiment of the present invention, the housing is ceramic. In one embodiment the housing is a one-piece, injection-molded ceramic housing. In an alternate embodiment, the housing is a one-piece, dry-press ceramic housing.

In an alternate embodiment of the present invention, a receptacle for a two wire temperature probe for use in an oven cavity of a cooking appliance is provided. The receptacle comprises a ceramic housing having a temperature probe connector receiver bore defined therein. This temperature probe connector receiver bore opens at an opposite end to form a groove in the housing. A pair of electrical terminals is positioned in spaced relation to one another along a longitudinal axis of the groove. Preferably, each of the electrical terminals has an electrical contact surface positioned transverse to the longitudinal axis of the groove. Alternatively, the electrical contact surfaces may be positioned in parallel to the longitudinal axis of the groove. This electrical contact surface is further positioned radially from the central axis of the groove at a distance at most equal to a radius of the connector receiver bore. In a highly preferred embodiment, the electrical contact surface is positioned radially from the central axis of the groove at a distance less than the radius of the connector receiver bore.

A preferred method of constructing a receptacle for a two wire temperature probe for use in an oven cavity of a cooking appliance in accordance with the present invention comprising the steps of forming a single piece ceramic housing having defined therein a connector receiver bore, a groove in communication with the bore, and a pair of terminal receiving slots or mounting holes extending through the housing and positioned along a longitudinal axis of the groove, and inserting an electrical terminal in each of the pair of terminal receiving slots. Alternatively, the step of inserting is replaced with the step of securing the electrical terminals to the housing. In one embodiment, the step of forming a single piece ceramic housing comprises the step of forming the housing via a ceramic injection-molding (CIM) process. In an alternate embodiment, the step of forming a single piece ceramic housing comprises the step of forming the housing via a dry press process.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is an isometric illustration of an embodiment of a ceramic receptacle of the present invention accommodating a male connector of a temperature probe;

FIG. 2 is a top view illustration of the embodiment of the ceramic receptacle of FIG. 1;

FIG. 3 is a side view illustration of the embodiment of the ceramic receptacle of FIG. 1;

FIG. 4 is a bottom view illustration of ceramic receptacle of the embodiment of FIG. 1;

FIG. 5 is an end view isometric illustration of the ceramic receptacle of the embodiment of FIG. 1;

FIG. 6 is an isometric illustration of the embodiment of the ceramic receptacle of FIG. 1 positioned to show contact detail with the male receptacle of the temperature probe;

FIG. 7 is an isometric illustration of the ceramic receptacle housing used to construct the ceramic receptacle of FIG. 1;

FIG. 8 is a side view illustration of the ceramic housing of FIG. 7;

FIG. 9 is a top view illustration of the ceramic housing of FIG. 7;

FIG. 10 is an isometric illustration of an electrical terminal inserted into the ceramic receptacle housing of FIG. 7 to construct the ceramic receptacle illustrated in FIG. 1;

FIG. 11 is a side view illustration of the electrical terminal of FIG. 10;

FIG. 12 is an isometric illustration of an alternate embodiment of a ceramic receptacle of the present invention;

FIG. 13 is an isometric illustration of one of the terminals of the ceramic receptacle of FIG. 12;

FIG. 14 is an isometric illustration of the other of the terminals of the ceramic receptacle of FIG. 12;

FIG. 15 is a top view isometric illustration of a further alternate embodiment of a ceramic receptacle of the present invention;

FIG. 16 is a bottom view isometric illustration of the further alternate embodiment of a ceramic receptacle of the present invention illustrated in FIG. 15;

FIG. 17 is a section view taken along section line 17-17 of FIG. 15 including a temperature probe male connector positioned therein;

FIG. 18 is a section view of the receptacle body of the embodiment illustrated in FIG. 15;

FIG. 19 is an isometric illustration of a top terminal of the ceramic receptacle of FIG. 15;

FIG. 20 is an isometric illustration of a bottom terminal of the ceramic receptacle of FIG. 15; and

FIG. 21 is an isometric illustration of a c-clip used to hold in position the ceramic receptacle of FIG. 15.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

While the apparatus and method of the present invention may find wide applicability to other applications, the following description will utilize one exemplary implementation of a temperature probe receptacle in a cooking appliance in the description that follows. However, such an exemplary implementation should not be taken as limiting the scope of the invention to any particular implementation. Therefore, the applicants reserve the full scope of the invention as defined in the claims appended hereto.

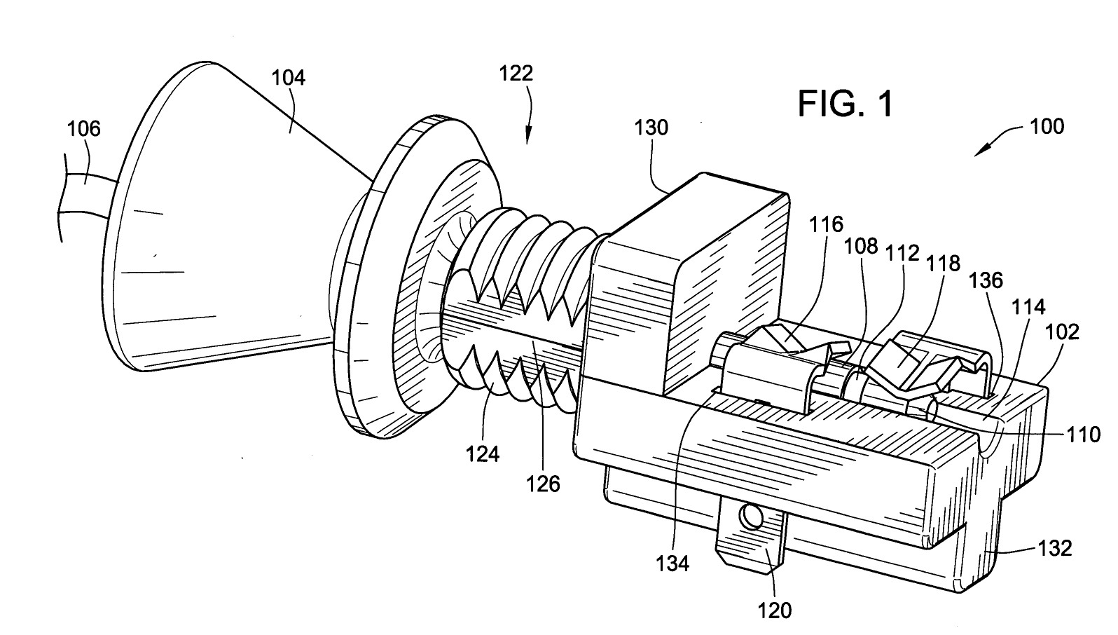

Turning now the drawings, a preferred embodiment of a receptacle constructed in accordance with the teachings of the present invention will be described. As may be seen from the isometric illustration of FIG. 1, an embodiment of a receptacle assembly 100 is illustrated as it engages a temperature probe connector end 104. In a preferred embodiment of the present invention the receptacle housing 102 is constructed from a high temperature resistant, electrically insulative material. Preferably, this material is ceramic. In preferred embodiments, the receptacle housing 102 is made by a ceramic injection molding (CIM) or dry press process that allows features for assembly to be integrated into the single piece housing 102. This results in a substantially reduced cost of manufacture as compared to the previous receptacles discussed above.

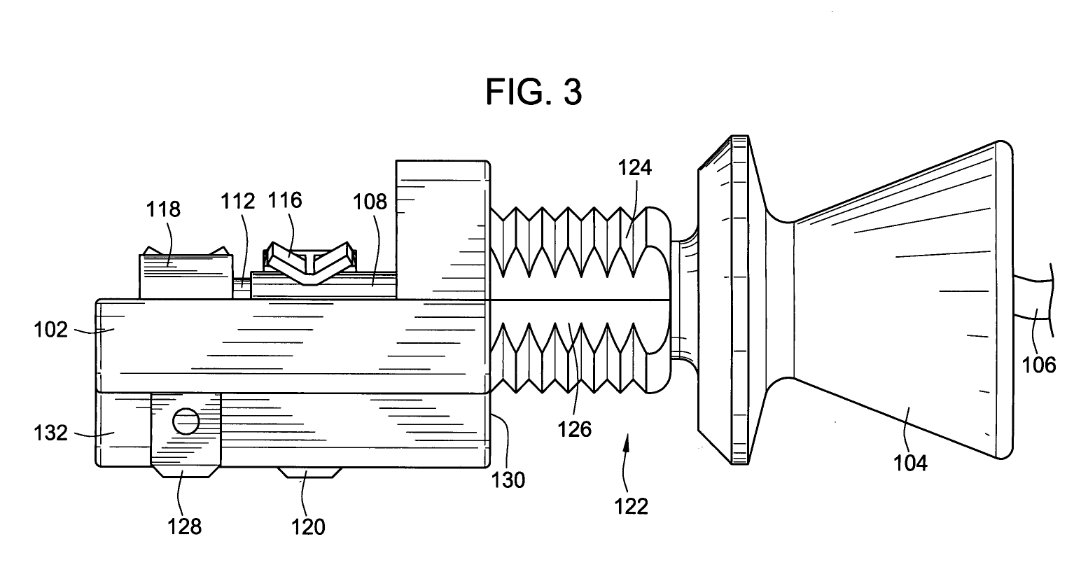

In addition to the receptacle housing 102, FIG. 1 illustrates the temperature probe connecter end 104 that is coupled by a temperature probe wire 106 to a temperature sensing element (not shown) that is typically inserted into the item being cooked. As will be recognized by those skilled in the art, a male connector having a first conductive portion 108 and a second conductive portion 110 separated by an insulator 112 extends from the connector end 104. To accommodate the male connector, the receptacle housing 102 is molded or formed with a receptacle groove 114 positioned therein to allow a first and second receptacle electrical terminals 116, 118 to make electrical contact with the first and second electrical conducting portions 108, 110 of the male connector of the temperature probe. Each of these electrical terminals 116, 118 include a terminal connector 120, 128 (see FIG. 3) to which the temperature sensing or control circuitry may be connected.

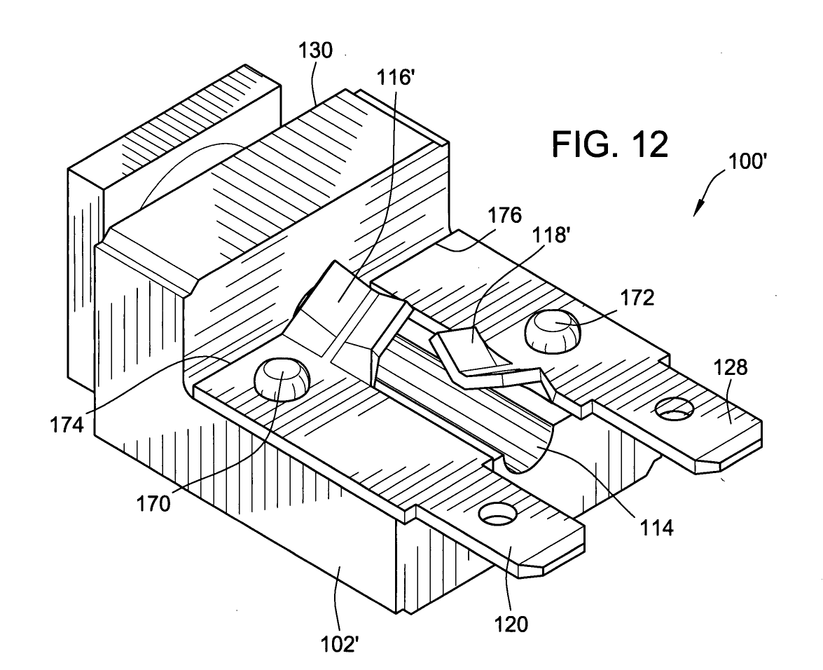

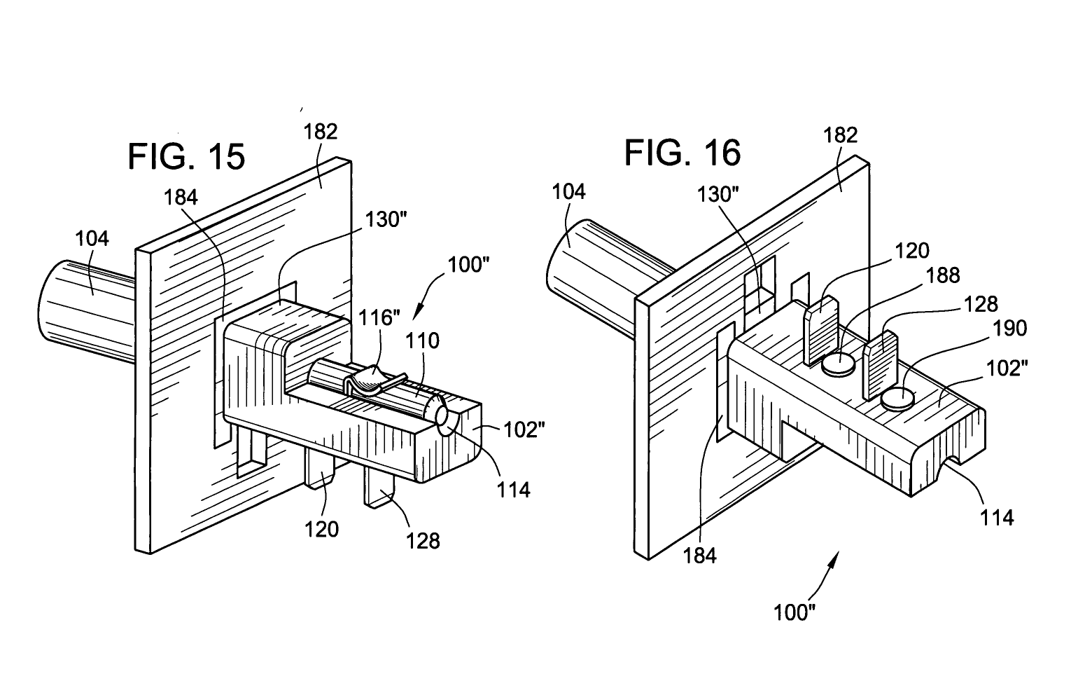

To allow the receptacle assembly 100 to be mounted within the cooking appliance, the receptacle housing 102 is molded or formed with a receptacle cavity interface 122. In the embodiment illustrated in FIG. 1, this receptacle cavity interface 122 is formed with connector threads 124 that allow the receptacle assembly 100 to be mounted in the sidewall of a cooking appliance using a nut or a threaded receiver. As is common with many molding processes, a mold flat 126 is also included on the receptacle cavity interface portion 122 of the receptacle housing 102. A receptacle shoulder 130 is also provided to add stability to the mounting of the receptacle assembly 100 in the sidewall of the cooking appliance. That is, the receptacle assembly 100 is inserted through a receiving bore, typically in the sidewall of the cooking appliance, until the sidewall meets with the receptacle shoulder 130. The retaining nut (not shown) is then threaded onto the receptacle cavity interface 122 to secure the receptacle assembly 100 in place. Alternative locking mechanisms may also be used as will be discussed below with regard to FIGS. 12 and 15.

To ensure proper placement and electrical isolation of the electrical terminals 116, 118, the receptacle housing 102 also provides a terminal separation structure 132 between the terminal connectors 120, 128. The housing 102 also has molded or formed therein terminal receiving slots 134, 136 into which the electrical terminals 116, 118 are inserted after the ceramic housing 102 has been finished. While these terminals could be integrally molded or formed during the molding of the housing 102, the requirement that ceramic be fired at temperatures typically in the 2200° F. to 2500° F. range precludes such integration, at least when the electrical terminals 116, 118 are made from conventional conductive materials.

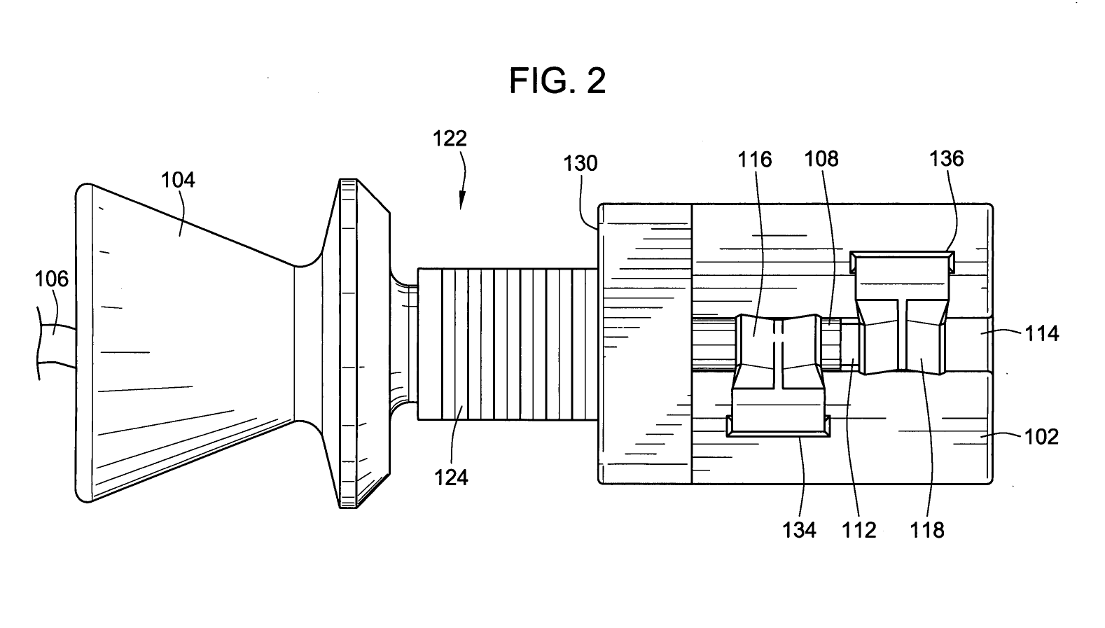

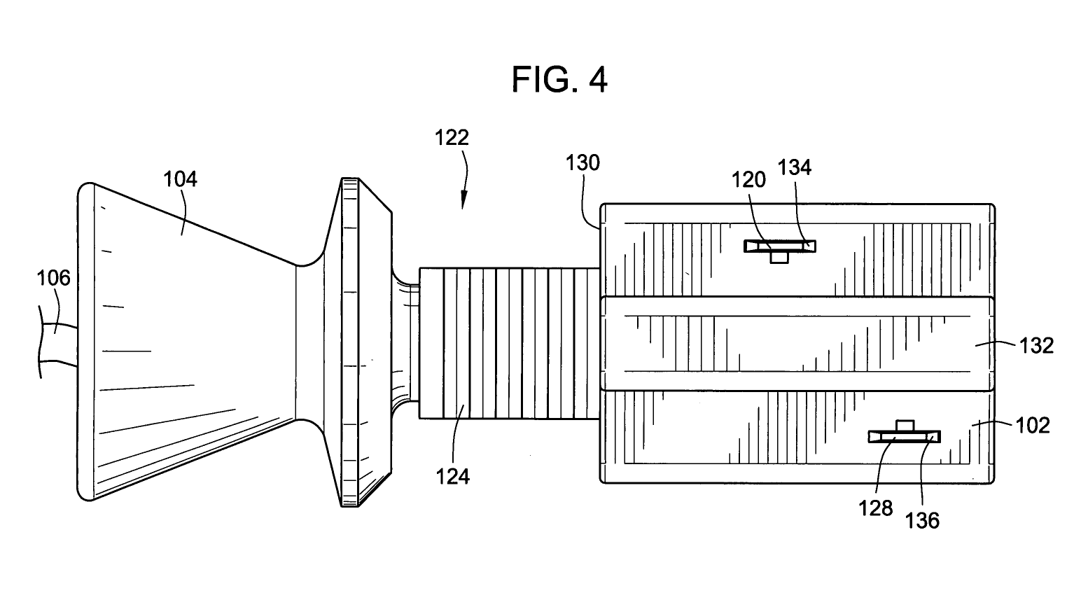

The top view illustration of FIG. 2 illustrates the placement of electrical terminals 116, 118 in relation to the male connector portion of the temperature probe. This relative placement may also be seen from the side view illustration of FIG. 3. The bottom view illustration of FIG. 4 also illustrates the functional relationship between the terminal separation structure 132 and each of the terminal connectors 120, 128.

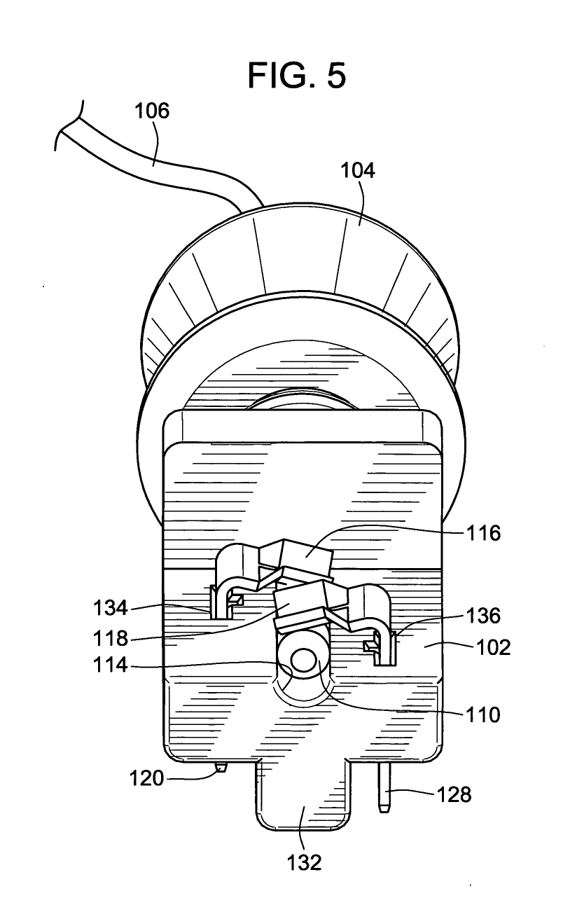

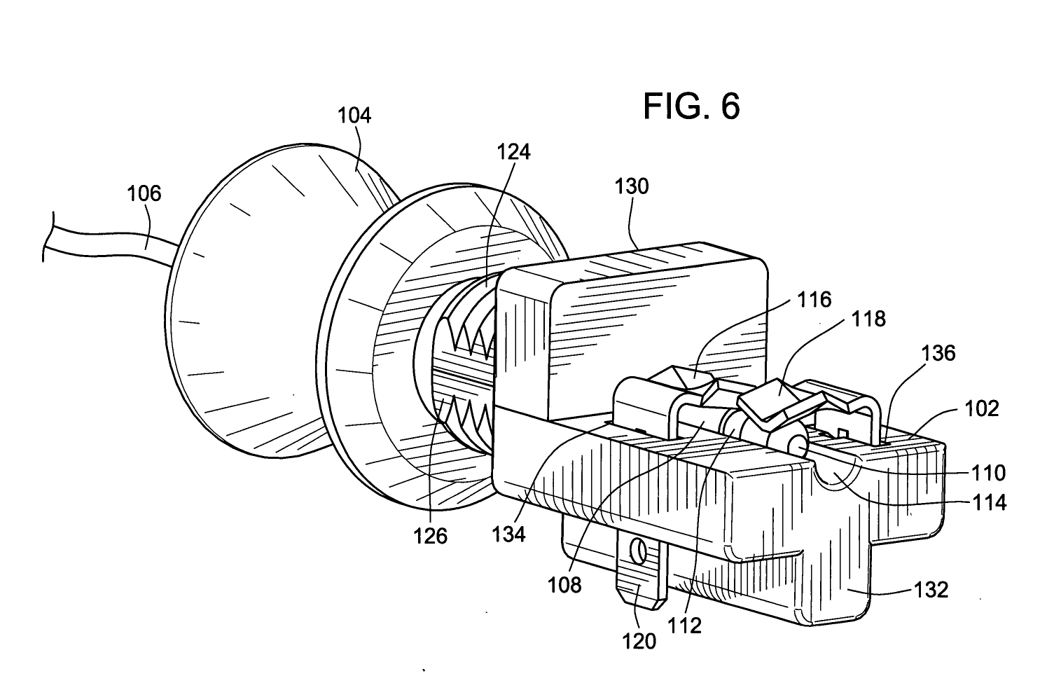

The end view isometric illustration of FIG. 5 illustrates the operative connection provided by electrical terminals 116, 118 to the male conductor of the temperature probe. As may be seen, each of these conductors 116, 118 provide a mechanical biasing force that ensures a consistent electrical connection to the temperature probe connector. This may also be seen from the isometric illustration of FIG. 6.

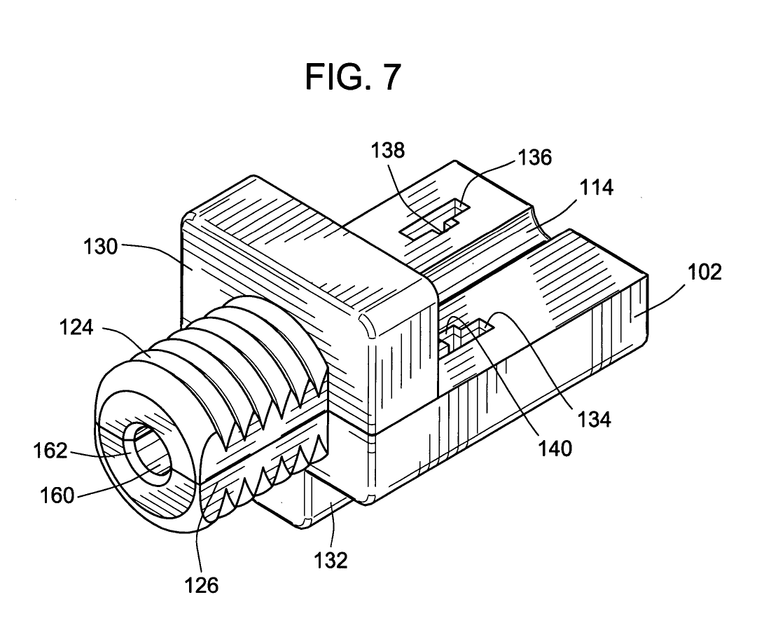

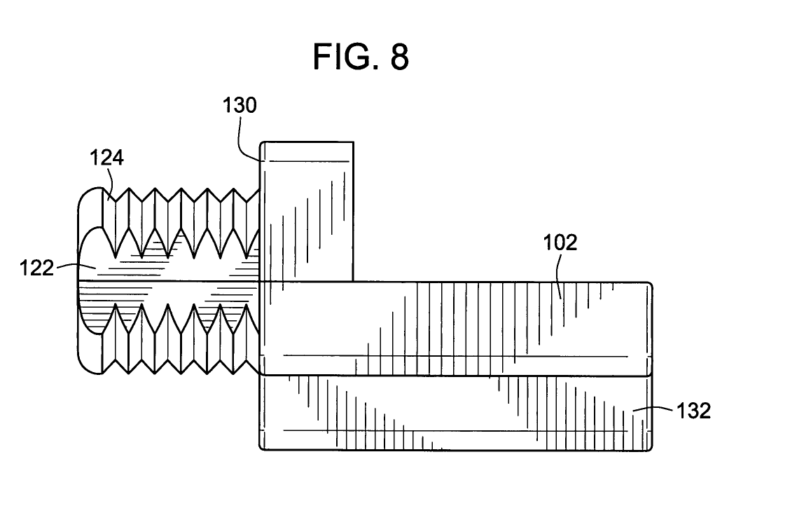

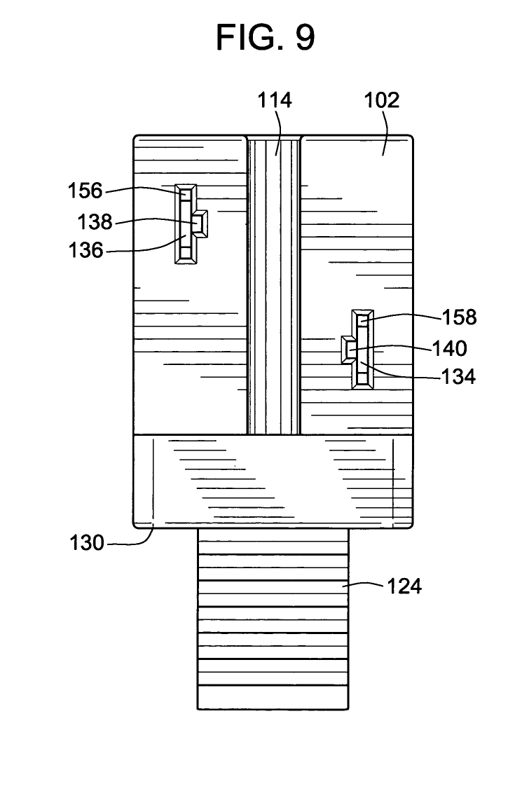

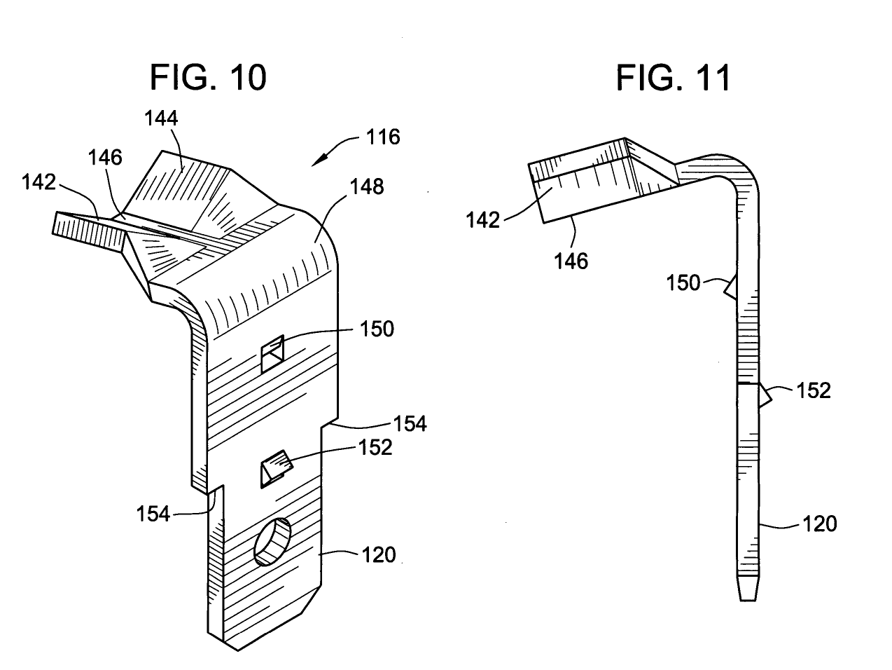

Turning now to FIGS. 7-9, details of the receptacle housing 102 may now be discussed in detail. As may be seen from FIGS. 7 and 9, each of the terminal receiving slots 134, 136 include locking tab receivers 138, 140 that will receive an upper locking tab 150 (see FIGS. 10 and 11) when the electrical terminals are inserted therein.

As may also be seen from FIG. 7, the receptacle cavity interface portion of housing 102 includes a temperature probe connector receiver passage or bore 160 formed therein. Preferably, this connector receiver 160 also includes a flared surface 162 to help guide and ease the entry of the male connector portion of the temperature probe. FIG. 7 also illustrates the mold flat 126 and the parting line between the two mold halves that result from the two dye halves coming together and meeting along that center line. This is because the typical molding process requires that there be a slight flat section for the parting line for mold purposes.

The electrical terminals inserted into the receptacle body 102 to complete the assembly 100 are illustrated in FIGS. 10 and 11. As may be seen, the electrical terminals 116 include a first and second angled surface 142, 144 on either side of a central contact surface 146. These angled surfaces 142, 144 accommodate insertion and extraction of the male connector of the temperature probe while the central contact surface 146 provides the actual mechanical and electrical connection to the male connector of the temperature probe. The mechanical bias is provided by a biased transition surface 148 which, as seen in FIG. 11, is bent over center. This ensures that when the male connector is inserted into the receptacle, it is firmly held in the receptacle groove to ensure a solid mechanical and electrical contact. To ensure proper positioning of the central contact surface above the groove 114 once the terminals are inserted into the body 102, each terminal includes a shoulder 154 that prevents the terminal 116 from being inserted too far through the slot 136. As may be seen from the top view illustration of body 102 illustrated in FIG. 9, each of the slots 134, 136 include slot shoulders 156, 158. Upper 150 and lower 152 locking tabs are also provided to hold the terminals 116 in place once inserted into the body 102.

FIG. 12 illustrates an alternate embodiment of a ceramic receptacle 100′ constructed in accordance with the teaching of the present invention. As may be seen from this alternate embodiment, the ceramic body 102′ still includes the receptacle groove 114 therethrough. However, in this alternate embodiment the terminal connectors 120, 128 do not penetrate the housing 102′ transverse to the groove 114. Instead, this embodiment 100′ of the present invention utilizes a rear end connection whereby terminals 120, 128 extend rearwardly from the housing 102′. The electrical terminals 116′, 118′ are secured to the housing 102′ via fasteners, e.g. rivets 170, 172. Other fasteners, such as screws, bolts, etc. may also be used to secure the electrical terminals 116′, 118′ to the ceramic receptacle body 102′. Rotation of the terminals 116′, 118′ is presented by the forward end 174, 176 of the electrical terminals 116′, 118′ abutting against the receptacle shoulder 130.

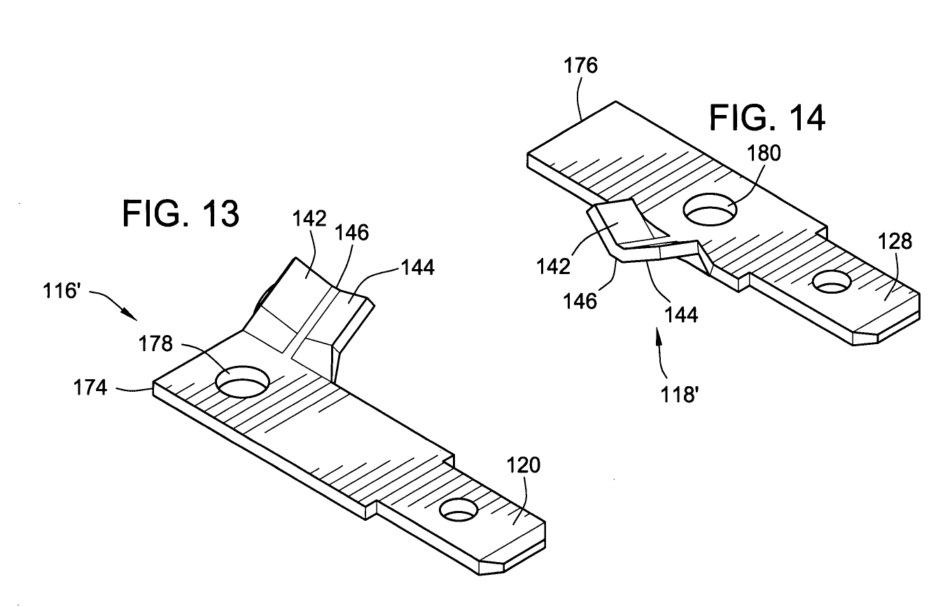

As may be seen from the illustrations of the electrical terminals 1116′ in FIGS. 13 and 118′ in FIG. 14, the rivets or other fasteners are accommodated by apertures 178, 180. Preferably, these apertures 178, 180 are positioned in alignment with the contact portion of the electrical terminals including the first and second angle surfaces 142, 144 and the central contact surface 146. In this way, a secure mechanical contact force can be maintained on the male connector.

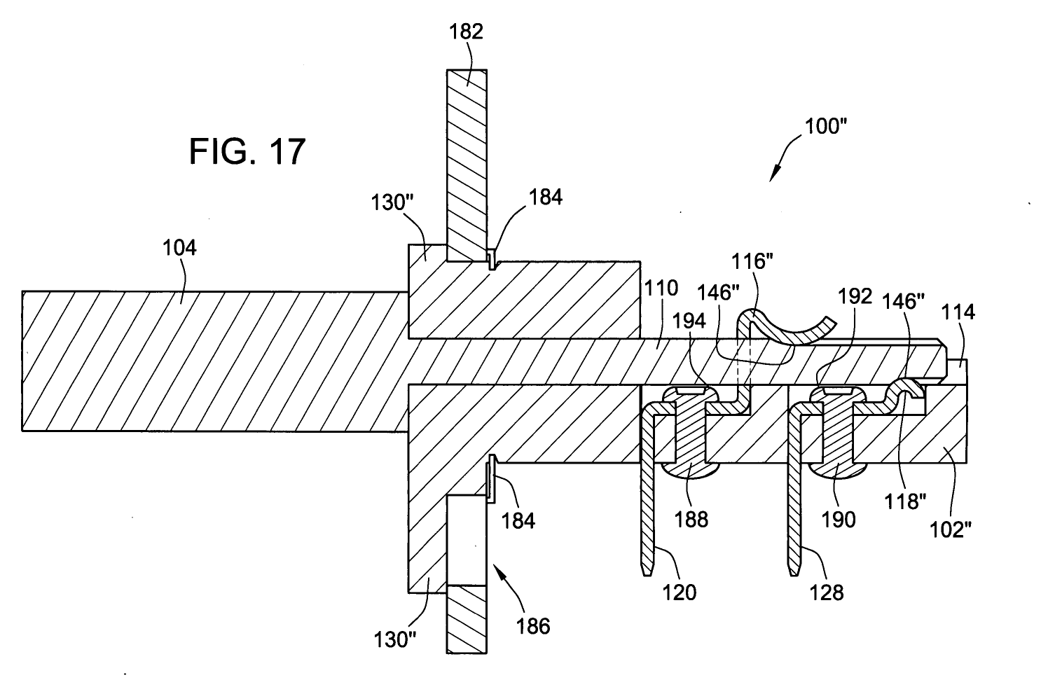

A further embodiment of a ceramic receptacle 100″ constructed in accordance with the teachings of the present invention is illustrated in FIG. 15. It is noted that this FIG. 15 also illustrates a portion of a mounting wall 182 through which the receptacle 100″ is mounted. As with the previous embodiments, this further alternate embodiment includes the central receptacle groove 114 which receives the male end connector 110. Unlike a previous embodiments where both electrical terminals made contact with the male connector 110 above the groove 114, in this embodiment only electrical connector 116″ makes such electrical contact. The other electrical contact 118″ makes its electrical contact with the male connector 110 along its underside when inserted into the housing 102″ (as may best be seen in the cross sectional illustration of FIG. 17).

In this embodiment, the body 102″ is held in place on the mounting wall 182 via a C-clip 184 that cooperates with the receptacle shoulder 130″ (see FIG. 17) to hold the receptacle 100″ in place. It is noted that in this embodiment the mounting wall 182 must include a cut-out 186 that not only accommodates the insertion of the receptacle body 102″, but also that accommodates the electrical connectors 120, 128 that depend from the housing 102″. The relationship of these electrical connectors 120, 128 may best be seen from the inverted illustration of FIG. 16. This FIG. 16 also illustrates the placement of the electrical terminal retainers, e.g. rivets 188, 190.

The cross sectional illustration of FIG. 17 illustrates the relative placement of the electrical terminals 116″, 118″ as they are held in place by fasteners 188, 190 while the male connector 110 is inserted into the ceramic receptacle during operation. As may be seen, the inner end of the fasteners 188, 190 are preferably no higher than the bottom surface of the groove 114, and are preferable countersunk slightly thereunder. In any event, the height of the contact surface 146″ of the electrical connector 118″ is preferably higher than, relative to the bottom edge of the groove 114, the top surface 192, 194 of the fasteners 188, 190.

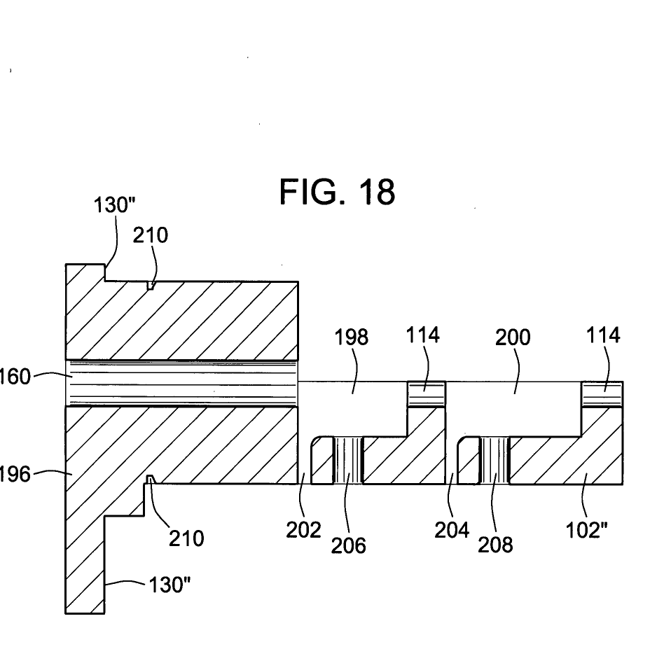

FIG. 18 illustrates in cross sectional view the ceramic receptacle body 102″ itself. As may be seen, the central bore 160 through the mounting portion 196 of the body 102″ aligns with the receptacle groove 114. Unlike previous embodiments, however, this groove 114 does not continue along the entire length of body 102″. Instead, two electrical terminal mounting wells 198, 200 are provided to accommodate the insertion and securing of the electrical terminals 116″, 118″. Each mounting well 198, 200 includes an electrical connector insertion slot 202, 204 that accommodates the terminal connectors 120, 128 for insertion therethrough. Each of the wells 198, 200 also includes a fastener bore 206, 208 that accommodates the insertion of the fasteners that will be used to hold the electrical terminals in place within the wells 198, 200.

As may also be seen from this cross sectional illustration of the body 102″ of FIG. 18, the receptacle shoulder 130″ exists to abut the opposite side of the mounting wall than the receptacle shoulder 130 of the previous embodiments. In this configuration, the body 102″ also includes a C-clip groove 210 to receive a C-clip when the body 102″ is mounted in its application. The positioning of this groove 210 is such to accommodate the thickness of the mounting wall through which this embodiment will be mounted.

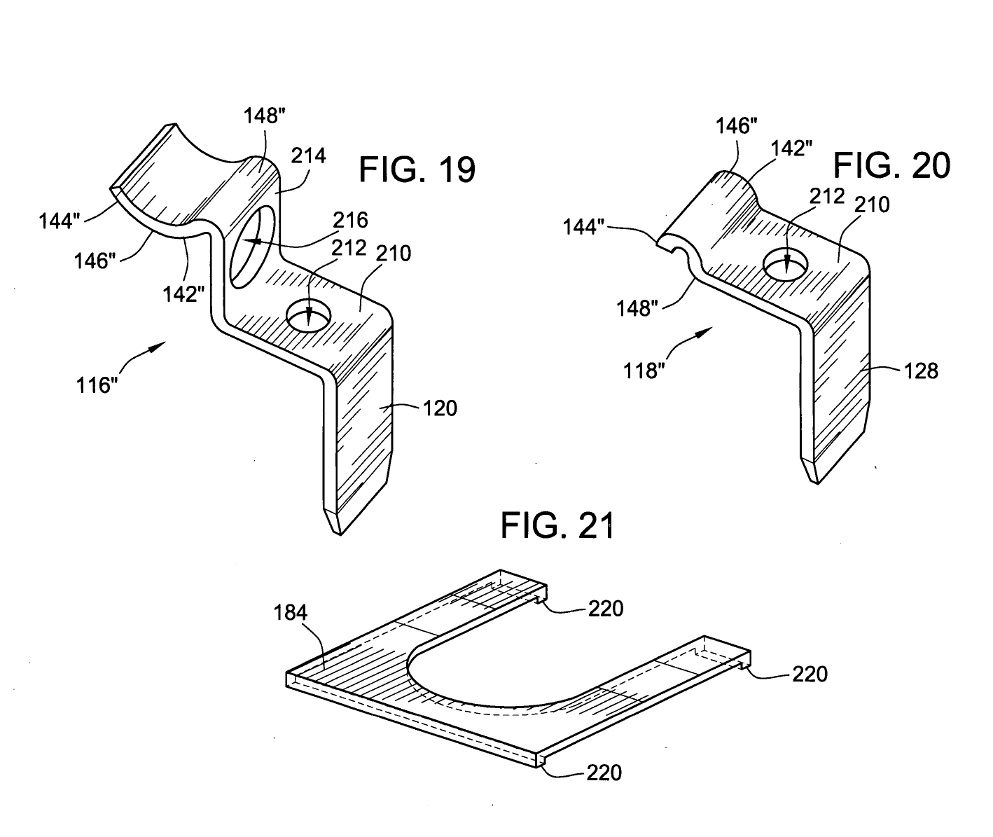

FIG. 19 illustrates the electrical terminal 116″. This electrical terminal 116″ includes the terminal connector 120 that extends through the terminal slot 202 for electrical connection to the sensing or control circuitry. The terminal 116″ also includes a mounting portion 210 that defines a mounting aperture 212 therein. The terminal 116″ also includes a transverse male connector accommodating surface 214 having a male connector aperture 216 provided therethrough. This aperture 216 is preferably sized to accommodate insertion of the male connector 110 therethrough. Preferably, the size of this aperture 216 is larger than the outer diameter of the male connector 110 so as to not interfere with its insertion into the receptacle 100″. Electrical connection with the male connector 110 is provided by the central contact surface 146″ of the terminal 116″. Unlike the previous embodiments of the connector, however, the angle surfaces 142″ and 144″ are in a curvilinear relationship with the contact surface 146″. The biased transition surface 148″ operates to ensure a mechanical bias of the surfaces 142″, 144″, 146″ against the male connector 110 when installed in housing.

FIG. 20 illustrates the electrical terminal 118″ employed in this embodiment of the present invention. As may be seen, the electrical terminal 128 is transversely positioned to the mounting surface 210, which also includes the securing aperture 212 therethrough. Since this terminal 118″ is mounted for electrical terminal contact under the male connector when inserted in the housing, the central contact surface 146″ and the angled surfaces 142″ and 144″ are positioned in close proximity to the mounting surface 210. Indeed, the biased transition surface 148″ provides the transition from this mounting surface 210 to the contact surfaces 142″-146″. The surfaces 142″-146″ are also in a curvilinear relationship with one another in this embodiment.

The C-clip 184 is illustrated in FIG. 21. Preferably, the C-clip 184 includes mounting wall contact feet 220 that will contact the mounting wall of the application in which the receptacle is to be utilized. This allows the mounting slot 210 (see FIG. 18) to be positioned slightly further from the shoulder 130″ then the thickness of the mounting wall to aid in insertion thereof, while still providing a biased force against the mounting wall to hold the receptacle 100″ firmly in place.

As may now be apparent to those skilled in the art, the receptacle of the present invention provides several advantages over previous receptacles. Because the material used to construct the receptacle body 102 is non-conducting, a standard inexpensive two-wire temperature probe may be utilized. This is because the receptacle body itself isolates the receptacle from chassis ground as is required by many electronic controls used in such applications. Additionally, the use of ceramic allows the receptacle to withstand the oven temperatures in excess of 900° F. which may occur during self-cleaning cycles of the range. By utilizing a dry press or ceramic injection molding (CIM) process, the ceramic housing 102 allows the features for assembly to be integrated into a single piece, resulting in a lower manufacturing cost.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A receptacle assembly, comprising
an insulative housing defining therein a connector receiver bore, a groove in communication with the bore, and a pair of terminal receiving slots extending through the housing and positioned along a longitudinal axis of the groove; and
a pair of electrical terminals positioned at axial spaced relation along the longitudinal axis of the groove, the electrical terminals having a contact surface positioned in a radial spaced relation to the longitudinal axis of the groove.

2. The receptacle assembly of claim 1, wherein the housing further defines a cavity interface portion around the connector receiver bore, the cavity interface portion including a threaded exterior surface.

3. The receptacle assembly of claim 1, wherein the housing further defines a cavity interface portion around the connector receiver bore, the cavity interface portion including a clip groove to accommodate a C-clip to secure the housing to an external mounting wall.

4. The receptacle assembly of claim 2, wherein the housing further defines a shoulder portion laterally spaced from an exterior end of the bore.

5. The receptacle assembly of claim 1, wherein the housing further defines a terminal separation structure extending between a pair of terminal receiving slots extending through the housing in transverse relationship to the groove.

6. The receptacle assembly of claim 1, wherein the housing defines a pair of terminal receiving slots extending therethrough, wherein each of the pair of electrical terminals includes a terminal shoulder formed thereon, wherein each of the terminal receiving slots includes a slot shoulder positioned therein, and wherein the terminal shoulder and the slot shoulder are positioned relative to one another to prevent the electrical terminal from being inserted too far in the terminal receiving slot.

7. The receptacle assembly of claim 1, wherein the electrical terminals include a terminal connector portion extending along and beyond an end of the groove.

8. The receptacle assembly of claim 1, wherein the housing defines a pair of terminal receiving slots extending therethrough, wherein each of the pair of electrical terminals includes a locking tab formed thereon, wherein each of the terminal receiving slots includes at least one locking tab receiver formed therein, and wherein the locking tab and the locking tab receiver are operative to inhibit removal of the electrical terminal from the terminal receiving slot once inserted therein.

9. The receptacle assembly of claim 1, wherein each of the electrical terminals includes a first and a second angled surface on either side of a central contact surface at one end thereof, and a terminal connector at an opposite end thereof.

10. The receptacle assembly of claim 9, wherein each of the electrical terminals further includes a biased transition surface between the one end and the opposite end thereof, the biased transition surface positioning the one end out of the plane of the opposite end thereof.

11. The receptacle assembly of claim 10, wherein the biased transition surface positions the one end at an acute angle relative to the opposite end.

12. The receptacle assembly of claim 1, wherein the housing is ceramic.

13. The receptacle assembly of claim 12, wherein the housing is a one-piece, injection-molded ceramic housing.

14. The receptacle assembly of claim 12, wherein the housing is a one-piece, dry-press ceramic housing.

15. The receptacle assembly of claim 1, wherein the housing defines a pair of terminal mounting wells therein, the terminal mounting wells including a terminal connector insertion slot extending through the housing.

16. The receptacle of claim 15, wherein the contact surface of one of the pair of electrical terminals is positioned in diametric opposition to the contact surface of the other of the pair of electrical terminals.

17. A receptacle for a two wire temperature probe for use in an oven cavity of a cooking appliance, the receptacle comprising:
a ceramic housing having a temperature probe connector receiver bore defined therein, the temperature probe connector receiver bore opening at an opposite end to form a groove in the housing; and
a pair of electrical terminals positioned in spaced relation to one another along a longitudinal axis of the groove.

18. The receptacle of claim 17, wherein each of the electrical terminals has an electrical contact surface positioned transverse to the longitudinal axis of the groove, the electrical contact surface further positioned radially from the central axis of the groove at a distance at most equal to a radius of the connector receiver bore.

19. The receptacle of claim 18, wherein the electrical contact surface is positioned radially from the central axis of the groove at a distance less than the radius of the connector receiver bore.

20. A method of constructing a receptacle for a two wire temperature probe for use in an oven cavity of a cooking appliance, the method comprising the steps of:
forming a single piece ceramic housing having defined therein a connector receiver bore, a groove in communication with the bore, and a pair of terminal apertures extending through the housing and positioned along a longitudinal axis of the groove; and
securing an electrical terminal in relation to the housing via the receiving aperture.

21. The method of claim 20, wherein the step of forming a single piece ceramic housing comprises the step of forming the housing via a ceramic injection-molding (CIM) process.

22. The method of claim 20, wherein the step of forming a single piece ceramic housing comprises the step of forming the housing via a dry press process.
